(19) United States
(12) Patent Application Publication
(10) Pub. No.: US 2021/0367375 A1
(43) Pub. Date: Nov. 25, 2021

(54) CLAMPING SOCKET ASSEMBLY AND METHOD

(71) Applicants: Kurt Allan Anderson, Sioux Falls, SD (US); William Larsen, Sioux Falls, SD (US)

(72) Inventors: Kurt Allan Anderson, Sioux Falls, SD (US); William Larsen, Sioux Falls, SD (US)

(21) Appl. No.: 17/100,369

(22) Filed: Nov. 20, 2020

Related U.S. Application Data
(60) Provisional application No. 63/101,905, filed on May 20, 2020.

(51) Int. Cl. H01R 13/622; H01R 43/22; H01R 13/639

(52) U.S. Cl. CPC H01R 13/622; H01R 13/639; H01R 43/22

(57) ABSTRACT

A clamping socket assembly and method includes positioning a fastener body in a collet. The collet has a first end and a second end, wherein the second end receives the body. The first end includes a tool mating member. The collet has a perimeter wall having a plurality of slots extending therein that extend into the second end to define a plurality of wings. A sleeve is positioned on the collet and is threadably coupled to the collet. The sleeve is rotated in a first direction to threadably couple the sleeve to the collet such that the sleeve moves toward the second end and urges the wings into frictional engagement with the fastener body. A tool is extended through the distal end and into the tool mating member. The tool is rotated to rotate the collet and the body.

### CROSS-REFERENCE TO RELATED APPLICATIONS

I hereby claim the benefit under 35 U.S.C. Section 119(e) of U.S. Provisional application 63/101,905 filed May 20, 2020.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to fastener head gripping device and more particularly pertains to a new fastener head gripping device for enhancing a grip between a socket and fastener head which has become worn or corroded.

### (2) Description of Related Art Including Information Disclosed Under 37 CFR 1.97 and 1.98

The prior art relates to fastener head gripping devices that are used for gripping bolt heads, nuts and other fastener bodies which have become worn and stripped wherein a conventional socket cannot maintain an adequate grip on the fastener body. Such devices do not, however, adequately compensate for the varied shapes of fasteners while simultaneously maximizing grip between a tool and the fastener.

### BRIEF SUMMARY OF THE INVENTION

An embodiment of the disclosure meets the needs presented above by generally comprising a collet that has a first end, a second end, and a perimeter wall extending between the first and second ends. The second end is open and receives a body of a threaded fastener such that an inner surface of the perimeter wall can frictionally engage the body. The perimeter wall has a plurality of slots extending therein. The slots extend into the second end and toward the first end to define a plurality of wings. An outer surface of the perimeter wall includes a threaded section positioned adjacent to the first end. A flaring section of the outer surface is positioned between the second end and the threaded section. The flaring section flares outwardly and increases in diameter as the flaring section extends away from the threaded section. The slots extend through the flaring section. A sleeve has a receiving end for receiving the first end. The sleeve also has an interior surface including internal threading that is threadably engageable with the threaded section of the collet. Rotation of the sleeve in a first direction relative to the collet moves the receiving end toward the second end. The sleeve has a smaller diameter adjacent to the receiving end than the second end of the collet. Thus, free ends of the wings are urged toward each other as the receiving end moves over the flaring section and toward the second end to decrease an interior diameter of the second end.

In a second embodiment, a method of engaging a fastener body includes positioning the body in a collet. The collet has a first end and a second end and the second end receives the body. The first end includes a tool mating member. The collet has a perimeter wall having a plurality of slots extending therein that extend into the second end to define a plurality of wings. A sleeve is positioned on the collet and includes a receiving end to receive the first end and a distal end positioned opposite of the receiving end. The distal end has an opening in communication with the tool mating member. The sleeve includes internal threading matable with a threaded section on an outer surface of the collet. The sleeve is rotated in a first direction to threadably couple the sleeve to the collet such that the receiving end moves toward the second end and urges the wings into frictional engagement with the body. A tool is engaged with the tool mating member. The tool is rotated to rotate the collet and the body.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a rear isometric view of a clamping socket assembly and method according to an embodiment of the disclosure.

FIG. 2 is a bottom isometric view of a collet of an embodiment of the disclosure.

FIG. 3 is a bottom isometric view of an embodiment of the disclosure.

FIG. 4 is a side view of an embodiment of the disclosure.

FIG. 5 is a cross-sectional view of an embodiment of the disclosure taken along line 5-5 of FIG. 4.

FIG. 6 is a cross-sectional view of an embodiment of the disclosure taken along line 6-6 of FIG. 3.

FIG. 7 is a cross-sectional view of an embodiment of the disclosure.

FIG. 8 is an in-use cross-sectional view of an embodiment of the disclosure.

FIG. 9 is a front isometric view of an embodiment of the disclosure.

FIG. 10 is a front isometric view of an embodiment of the disclosure.

FIG. 11 is a front isometric view of an embodiment of the disclosure.

FIG. 12 is a front isometric view of an embodiment of the disclosure.

FIG. 13 is a front isometric view of an embodiment of the disclosure.

FIG. 14 is a bottom isometric view of another embodiment of the disclosure.

FIG. 15 is a front isometric view of the embodiment of the disclosure depicted in FIG. 14.

FIG. 16 is a front isometric view of an embodiment of the disclosure.

### DETAILED DESCRIPTION OF THE INVENTION

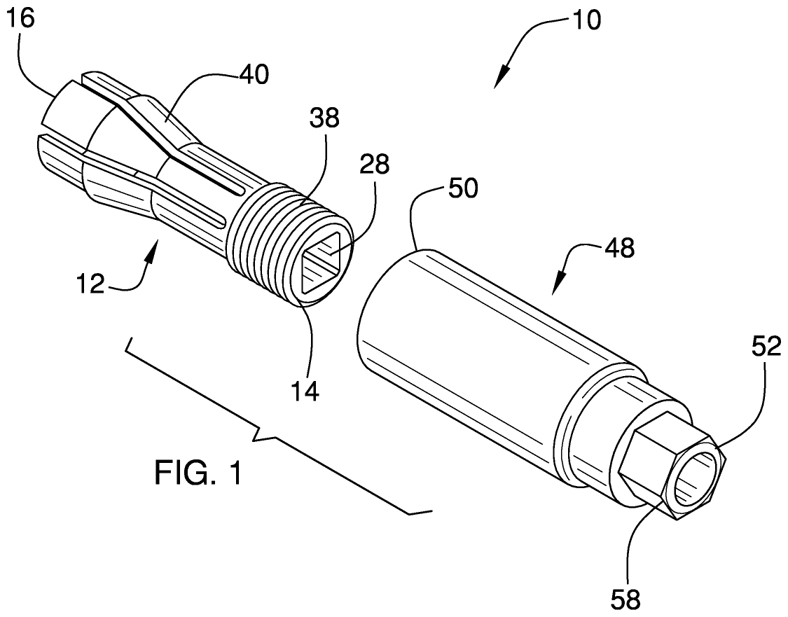

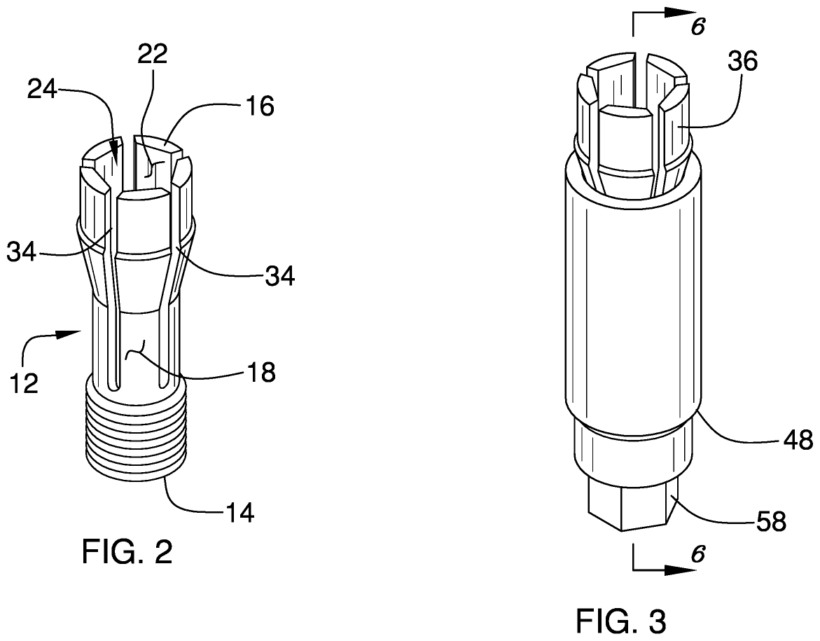

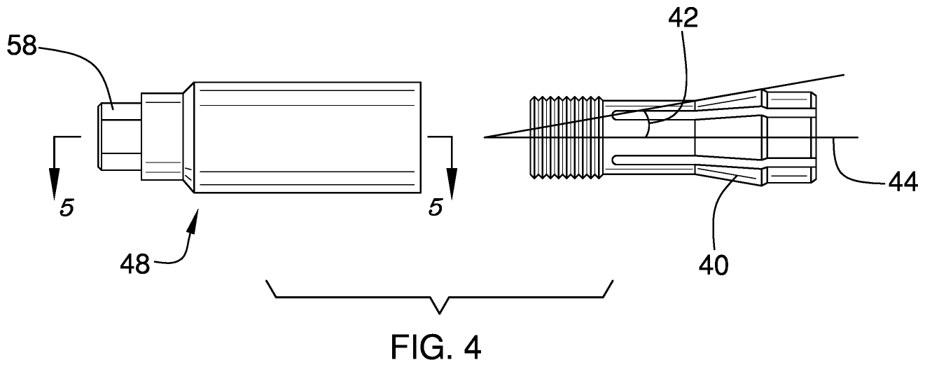

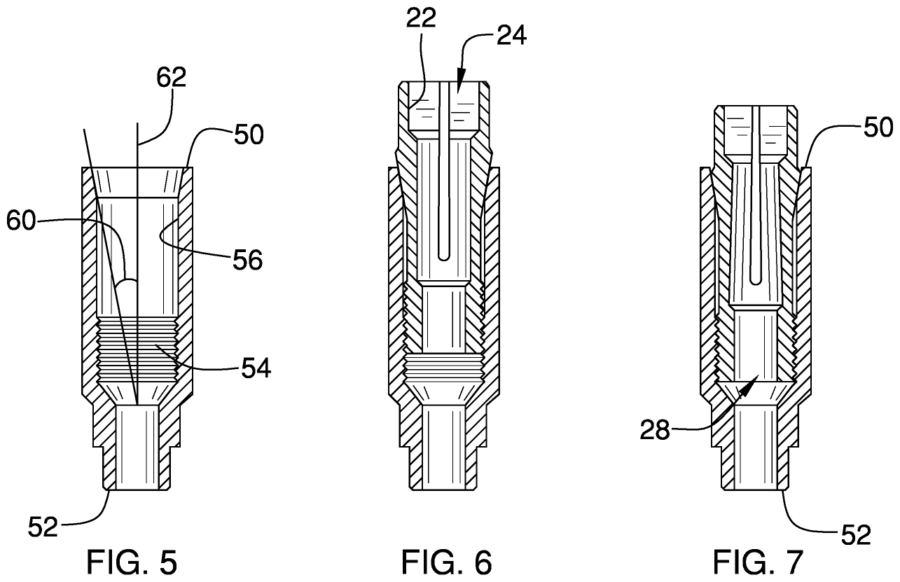

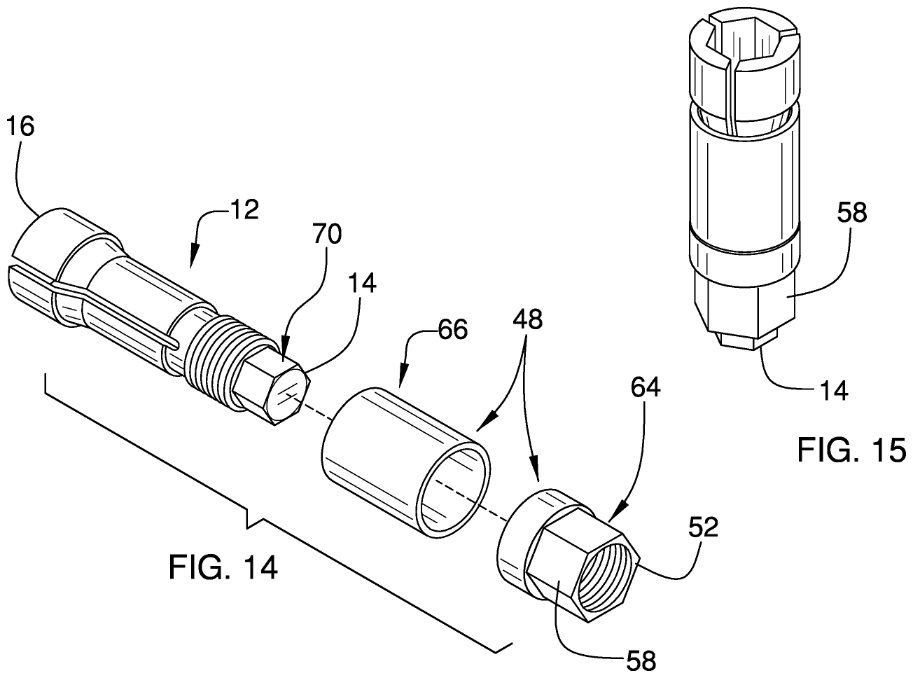

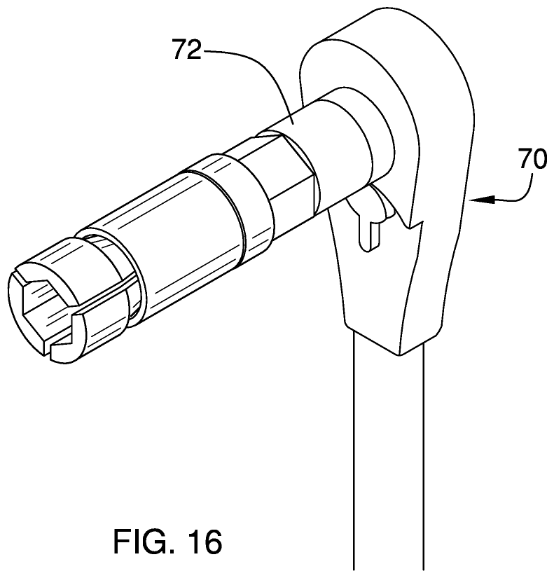

With reference now to the drawings, and in particular to FIGS. 1 through 16 thereof, a new fastener head gripping device embodying the principles and concepts of an embodiment of the disclosure and generally designated by the reference numeral 10 will be described.

As best illustrated in FIGS. 1 through 16, the clamping socket assembly 10 and method generally comprises a collet 12 having a first end 14, a second end 16, and a perimeter wall 18 extending between the first 14 and second 16 ends. The second end 16 is open and is configured to receive a body 20 such that an inner surface 22 of the perimeter wall 18 can frictionally engage the body 20. The body 20 will typically comprise the outer periphery of a threaded fastener such as a bolt head, nut, or other surface typically gripped by a socket for rotating the body 20 while it is tightened or loosened. An opening 24 which extends into the second end 16 will have a size that is equal to or very slightly larger than a comparable socket that would be used with the body 20 to ensure that the opening 24 is capable of receiving the body 20. The opening 24 may have a typically geometric shape found with sockets including hexagons, pentagons, squares, triangles, and the like though circular and oblong shapes may also be utilized. Embodiments may further be presented that utilize an opening 24 having a surface comprising multiple teeth 26.

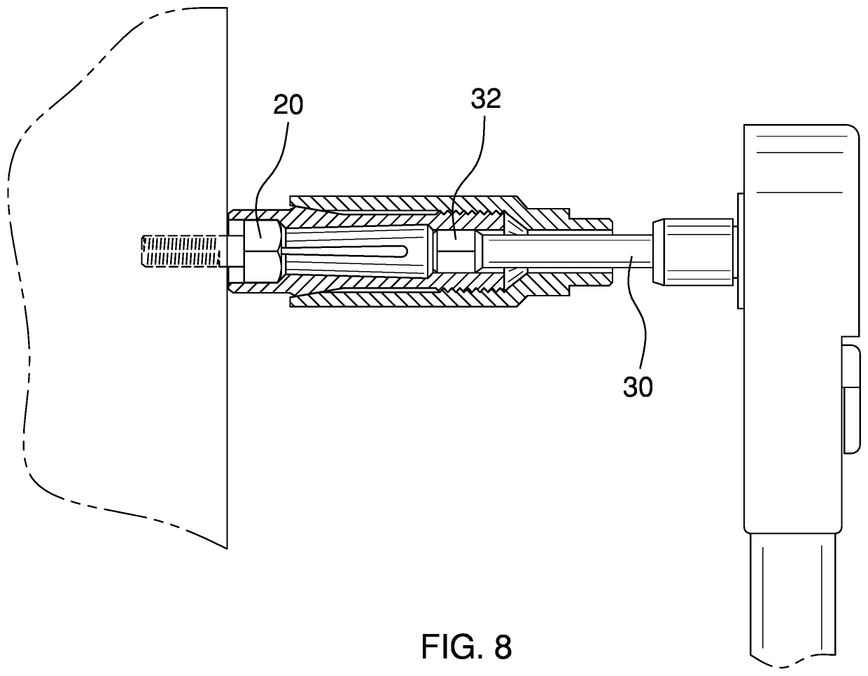

The first end 14 may include a tool mating member 28 for engaging a tool 30. The tool mating member 28 may include a well having a geometric shape for receiving the end of the tool 30. The geometric shape may include a square shown in FIG. 1, though other shapes having angular components such as hexagons may be used, or teeth may be formed within the tool mating member 28 for engaging the tool 30. The tool 30 may comprise any conventional tool and particularly those utilized with sockets. FIG. 8 shows one such tool 30 comprising a socket extension bar having a squared end 32 for fitting in a square shaped tool mating member 28.

In another embodiment found in FIGS. 14 through 16, the tool engaging member 70 comprises a bolt head type of structure wherein a socket 72 can be utilized to receive and engage the tool engaging member 70. This tool engaging head 70 may be advantageous over tool engaging head 28 where the user is working within a space not having the required depth that will allow for the 30 to be elongated. The tool engaging member 70 of FIGS. 14 through 16 will allow the socket 72, pliers or a conventional wrench to engage an outer surface of the perimeter wall 18 adjacent to the first end 14 and perpendicular to a longitudinal axis 44 of the collet 12. Generally, tool engaging member 70 will also provide for a shorter overall assembly 10 as will be further understood below.

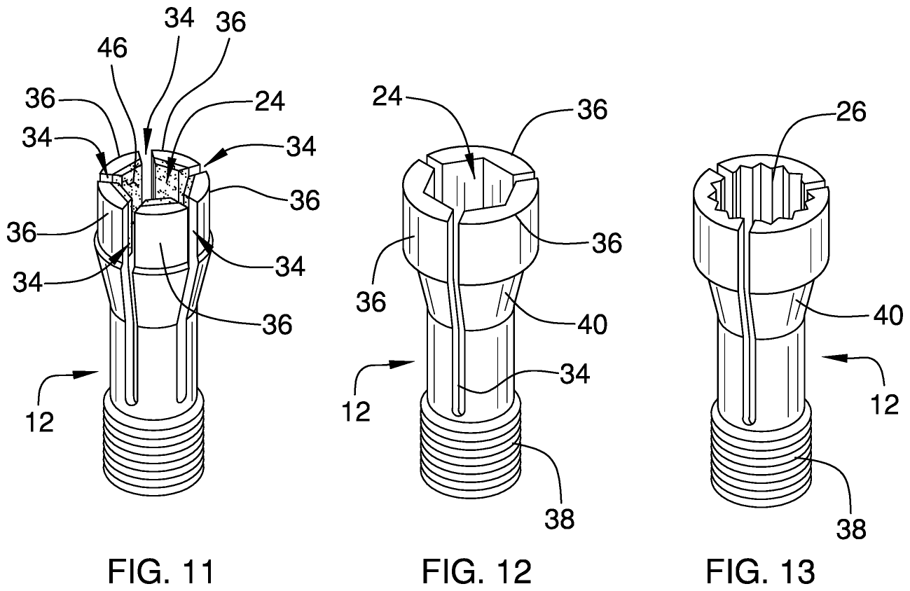

The perimeter wall 18 of the collet 12 has a plurality of slots 34 extending therein. The slots 34 extend into the second end 16 and toward the first end 14 to define a plurality of wings 36. The slots 34 allow the wings 36 to be movable inwardly toward the opening 24 in the second end to decrease a diameter of the opening 24. The number of slots 34, and consequently the number of wings 36, may vary as can be seen in FIGS. 11-13. Typically, the number of slots 34 will be at least three slots and no more than six slots. The outer surface of the perimeter wall 18 includes a threaded section 38 that is positioned adjacent to the first end 14. A flaring section 40 of the outer surface of the perimeter wall 18 is positioned between the second end 16 and the threaded section 38. The flaring section 40 flares outwardly and increases in diameter as the flaring section 40 extends away from the threaded section 38. As can be seen in the Figures, the slots 34 extend through the flaring section 40. The outer surface of the flaring section 40 forms an acute angle 42 with the longitudinal axis 44 of the collet 12 wherein the acute angle 42 is typically between 5° and 20°.

The collet 12 is comprised of a unitary structure. In particular, the unitary structure will be a single piece of a metal metallic material such as steel alloys, though any material used for tools such as wrenches and the like may be utilized. As can be seen in FIG. 11, friction enhancing 46 materials may be attached to an inner surface of the wings 36 to facilitate gripping of the body 20 by the collet 12.

A sleeve 48 is provided that has a receiving end 50 for receiving the first end 14 of the collet 12. The sleeve 48 has a distal end 52 with respect to the receiving end 50. The distal end 52 is open and is in communication with the tool mating member 28 such that the tool 30 is extendable through the distal end 52 and into the tool mating member 28 to engage the tool 30 with the tool mating member 28. This will allow the collet 12 to be rotatable with the tool 30. In the embodiment shown in FIG. 16, the sleeve 48 has shortened length such that the tool engaging member 70 extends through the receiving end 50.

The sleeve 48 has an interior surface 56 including internal threading 54 that is threadably engageable with the threaded section 38 of the collet 12. Rotation of the sleeve 48 in a first direction, relative to the collet 12 being stationary, moves the receiving end 50 toward the second end 16 and further along the collet 12 while rotation in a second direction removes the sleeve 48 from the collet 12. The sleeve 48 has a smaller diameter adjacent to the receiving end 50 than the second end 16 such as the sleeve 48 moves toward the second end 16, free ends of the wings 36 are urged toward each other. In particular, the flaring section 40 engages the interior surface 56 to decrease an interior diameter of the second end 16. In order to facilitate rotation of the sleeve 48 relative to the collet 12, an exterior surface of the sleeve 48 includes gripping section 58 having a conventional geometric cross-section such as a square or hexagon that can be easily gripped by a wrench or socket. The gripping section 58 may be positioned adjacent to the distal end 52 as shown in FIG. 1.

The interior surface 56 of the sleeve 48, adjacent to the receiving end 50, may taper inward such that an internal diameter of the sleeve 48 decreases from the receiving end 50 toward the distal end 52. This forms an acute angle 60 between the interior surface 56 and a longitudinal axis 62 of the sleeve 48 which is between 5° and 20°. This will create a larger surface area of contact between the internal surface 56 of the sleeve 48 and the outer surface of the flaring section 40 as can be seen in FIGS. 6 and 7. It should be understood, however, that the interior surface 56 need not taper for the assembly 10 to function as intended.

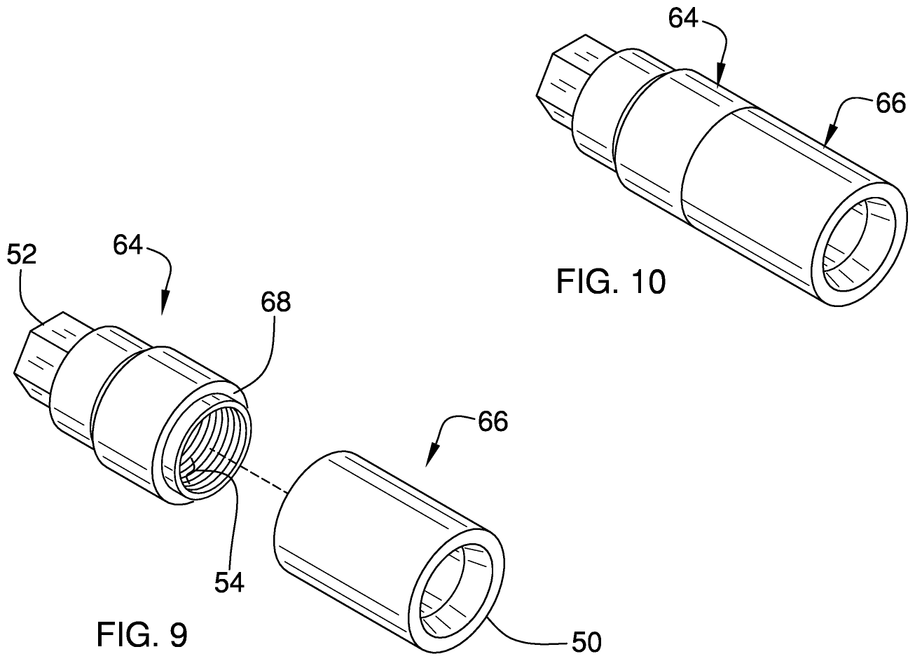

The sleeve 48, as with the collet 12, may be formed from a unitary structure and be comprised of the same material as the collet 12. Alternatively, as shown in FIGS. 9 and 10, the sleeve 48 may have a break therein to include a first section 64 distinct from a second section 66. The first section 64 includes the distal end 52 and the internal threading 54 while the second section 66 includes the receiving end 50. The first section 64 engages the threaded section 38 of the collet 12 while the second section 66 floats between the first section 64 and the second end 16 of the collet 12. The first section 64 includes a shoulder 68 that is abutted against the second section 66 to urge the second section 66 toward the second end 16 of the collet 12 when the first section 64 is rotated relative to the collet 12. While the embodiment of FIG. 14 includes first 64 and second 66 sections, it should be understood that this embodiment may include a sleeve 48 with a unitary structure as well.

In use, when a person encounters a bolt head, nut, or other body 20 threadably coupled to another fastener or article, wherein the body 20 is damaged and cannot be gripped adequately with a conventional wrench or socket, the person selects a collet 12 of appropriate size and extends the body 20 into the second end 16. The sleeve 48 is rotated in the first direction to move the sleeve 48 toward the second end 16 and causing constrictive biasing against the flaring section 40. This in turn urges the wings 36 inward toward each other to decrease a diameter of the opening 24 and create a frictional engagement of the wings 36 with the body 20. The gripping section 58 may be engaged with a wrench or other tool offering greater torque to fully tighten the wings 36 onto the body 20. The tool 30 is then engaged with the tool mating member 28 to allow the collet 12 to be rotated with the tool 30, which may include, for example, a bar coupled to a ratchet as shown in FIG. 8 or a socket 72 attached to a ratchet. The wings 36 prevent slippage between the body 20 and the tool 30 and can be used when the body 20 has become corroded or otherwise stripped of planar sides with sharp, easily gripped edges.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A clamping socket assembly configured to have an adjustable inner diameter to alter a frictional force being applied to an outer surface of a body having a threaded connection wherein the threaded connection is released when the body is rotated by a tool engaged with the clamping socket assembly, the assembly including:
a collet having a first end, a second end, and a perimeter wall extending between the first and second ends, the second end being open and being configured to receive a body such that an inner surface of the perimeter wall can frictionally engage the body;
the perimeter wall having a plurality of slots extending therein, the slots extending into the second end and extending toward the first end to define a plurality of wings;
an outer surface of the perimeter wall including a threaded section positioned adjacent to the first end;
a flaring section of the outer surface being positioned between the second end and the threaded section, the flaring section flaring outwardly and increasing in diameter as the flaring section extends away from the threaded section, the slots extending through the flaring section;
a sleeve having a receiving end for receiving the first end; and
the sleeve having an interior surface including internal threading and being threadably engageable with the threaded section of the collet, wherein rotation of the sleeve in a first direction moves the receiving end toward the second end, the sleeve having a smaller diameter adjacent to the receiving end than the second end such that free ends of the wings are urged toward each other as the receiving end moves over the flaring section and toward the second end to decrease an interior diameter of the second end.

2. The clamping socket assembly according to claim 1, wherein the first end includes a tool mating member for engaging a tool, the sleeve having a distal end with respect to the receiving end, the distal end being open and in communication with the tool mating member to allow the tool to extend through the distal end and engage the tool mating member.

3. The clamping socket assembly according to claim 1, wherein the first end includes a tool mating member for engaging a tool, the sleeve having a distal end with respect to the receiving end, the distal end being open to allow said first end to extend through said distal end such to allow the tool to engage the tool mating member.

4. The clamping socket assembly according to claim 1, wherein the interior surface of the sleeve adjacent to the receiving end tapers inward such that an internal diameter of the sleeve decreases from the receiving end toward the distal end.

5. The clamping socket assembly according to claim 2, wherein the sleeve has a break therein and including a first section and a second section, the first section including the distal end and the internal threading, the second section including the receiving end.

6. The clamping socket assembly according to claim 3, wherein the sleeve has a break therein and including a first section and a second section, the first section including the distal end and the internal threading, the second section including the receiving end.

7. The clamping socket assembly according to claim 5, wherein the first section includes a shoulder being abuttable against the second section to urge the second section toward the second end of the collet.

8. The clamping socket assembly according to claim 6, wherein the first section includes a shoulder being abuttable against the second section to urge the second section toward the second end of the collet.

9. A clamping socket assembly configured to have an adjustable inner diameter to alter a frictional force being applied to an outer surface of a body having a threaded connection wherein the threaded connection is released when the body is rotated by a tool engaged with the clamping socket assembly, the assembly including:
a collet having a first end, a second end, and a perimeter wall extending between the first and second ends, the second end being open and being configured to receive a body such that an inner surface of the perimeter wall can frictionally engage the body, the first end including a tool mating member for receiving a tool;
the perimeter wall having a plurality of slots extending therein, the slots extending into the second end and extending toward the first end to define a plurality of wings;
an outer surface of the perimeter wall including a threaded section positioned adjacent to the first end;
a flaring section of the outer surface being positioned between the second end and the threaded section, the flaring section flaring outwardly and increasing in diameter as the flaring section extends away from the threaded section, the slots extending through the flaring section;
a sleeve having a receiving end for receiving the first end, the sleeve having a distal end with respect to the receiving end, the distal end being open and being in communication with the tool mating member, wherein the tool is extendable through the distal end and into the tool mating member to engage and rotate the collet;
the sleeve having an interior surface including internal threading and being threadably engageable with the threaded section of the collet, wherein rotation of the sleeve in a first direction moves the receiving end toward the second end, the sleeve having a smaller diameter adjacent to the receiving end than the second end such that free ends of the wings are urged toward each other as the receiving end moves over the flaring section and toward the second end to decrease an interior diameter of the second end;
the interior surface of the sleeve adjacent to the receiving end tapering inward such that an internal diameter of the sleeve decreases from the receiving end toward the distal end; and
the sleeve having a break therein and including a first section and a second section, the first section including the distal end and the internal threading, the second section including the receiving end, the first section including a shoulder being abuttable against the second section to urge the second section toward the second end of the collet.

10. A method of gripping a body of a threaded fastener, the method including:
positioning the body in a collet, the collet having a first end and a second end, the second end receiving the body, the first end including a tool mating member, the collet having a perimeter wall having a plurality of slots extending therein, the slots extending into the second end to define a plurality of wings;
positioning a sleeve on the collet, the sleeve having a receiving end receiving the first end and a distal end positioned opposite of the receiving end, the distal end having an opening therein being in communication with the tool mating member, the sleeve including internal threading, the collet having an outer surface including a threaded section;
rotating the sleeve in a first direction to threadably couple the sleeve to the collet such that the receiving end moves toward the second end and urges the wings into frictional engagement with the body;
engaging the tool mating member with the tool; and
rotating the tool to rotate the collet and the body.

11. The method of gripping a body of a threaded fastener according to claim 10, the method further including the sleeve abutting a flaring section of the outer surface, the flaring section being positioned between the second end and the threaded section, the flaring section flaring outwardly and increasing in diameter as the flaring section extends away from the threaded section, the slots extending through the flaring section.

12. The method of gripping a body of a threaded fastener according to claim 11, the method further including the interior surface of the sleeve adjacent to the receiving end tapering inward such that an internal diameter of the sleeve decreases from the receiving end toward the distal end.

13. The method of gripping a body of a threaded fastener according to claim 12, the method further including the sleeve having a break therein and including a first section and a second section, the first section including the distal end and the internal threading, the second section including the receiving end, the first section including a shoulder, the shoulder being abuttable against the second section to urge the second section toward the second end of the collet when the first section is rotated relative to the collet.

14. The method of gripping a body of a threaded fastener according to claim 10, the method further including the sleeve having a break therein and including a first section and a second section, the first section including the distal end and the internal threading, the second section including the receiving end, the first section including a shoulder, the shoulder being abuttable against the second section to urge the second section toward the second end of the collet when the first section is rotated relative to the collet.
